(19) United States
(12) Patent Application Publication
(10) Pub. No.: US 2012/0222009 A1
(43) Pub. Date: Aug. 30, 2012

(54) DEFECTIVE CODE WARNING RESOLUTION ANALYSIS

(76) Inventors: Nathaniel E. Ayewah, Seattle, WA (US); Yue Yang, Redmond, WA (US); David J. Sielaff, Seattle, WA (US); Donn S. Terry, Woodinville, WA (US); Sunny Chatterjee, Bothell, WA (US); Vincent C. Smith, Seattle, WA (US); Christian Boehn, Redmond, WA (US)

(21) Appl. No.: 13/034,500

(22) Filed: Feb. 24, 2011

(51) Int. Cl. G06F 9/44

(52) U.S. Cl. 717/124

(57) ABSTRACT

In embodiments of defective code warning resolution analysis, defective code warnings are received, such as code development warnings and/or code execution warnings. The defective code warnings can be grouped into warning groups according to properties of each defective code warning. Each instance of a defective code warning in a warning group can then be determined as one of fixed, suppressed, or ignored. Each instance of the defective code warning in the warning group is also aggregated based on each warning state of fixed, suppressed, or ignored.

### BACKGROUND

Large-scale software development projects are complicated to manage and build, and many developers, working independently, author source code that is later compiled to develop a software application, such as an operating system or browser application. An extensive software build project may include thousands, or hundreds of thousands, of source code files, all authored by different developers, yet having any number of inter-related dependencies. The developers can face lengthy and complex challenges when compiling the thousands of source code files, particularly when changes are made to one source code file that may affect any number of other source code files and/or the dependencies. The impact of source code changes to other source code files may cause unexpected results and code build failures.

Developers utilize desktop static code analysis tools to investigate and resolve defect warnings that may be caused by the source code changes, unexpected results, and code build failures. However, conventional static code analysis tools do not provide a feedback mechanism to determine what resolution actions, if any, a developer initiates to resolve an instance of a defect warning. Additionally, static analysis defect warning instances are transitory in nature and difficult to track or assess. Conventional desktop static analyzers do not keep track of states between analysis executions, and it is not determinable whether an instance of a defect warning is a new warning, is a previously existing warning, or even if the instance of the defect warning has been resolved.

### SUMMARY

This Summary introduces simplified concepts of defective code warning resolution analysis, and the concepts are further described below in the Detailed Description and/or shown in the Figures. This Summary should not be considered to describe essential features of the claimed subject matter, nor used to determine or limit the scope of the claimed subject matter.

Defective code warning resolution analysis is described. In embodiments, defective code warnings are received, such as code development warnings and/or code execution warnings. The defective code warnings can be grouped into warning groups according to properties of each defective code warning. Each instance of a defective code warning in a warning group can then be determined as one of fixed, suppressed, or ignored. Each instance of the defective code warning in the warning group is also aggregated based on each warning state of fixed, suppressed, or ignored.

In other embodiments, an instance of a defective code warning can be determined as fixed based on a repair of defective code that caused the defective code warning to be initiated. Alternatively, the defective code warning can be determined as suppressed based on implementation of a warning bypass that eliminates a reoccurrence of the defective code warning. Alternatively, the defective code warning can be determined as ignored if the defective code warning is not determined as fixed or suppressed.

In other embodiments, the aggregated instances of a defective code warning in a warning group can be analyzed to infer a diagnostic response behavior to the defective code warning based on the warning states of fixed, suppressed, or ignored. Alternatively or in addition, The aggregated instances of a defective code warning in a warning group can be analyzed to infer one or more response trends to the defective code warning based on the warning states of fixed, suppressed, or ignored.

### BRIEF DESCRIPTION OF THE DRAWINGS

Embodiments of defective code warning resolution analysis are described with reference to the following Figures. The same numbers may be used throughout to reference like features and components that are shown in the Figures:

FIG. 1 illustrates an example system in which embodiments of defective code warning resolution analysis can be implemented.

FIG. 2 illustrates an example of a warning group for instances of a defective code warning in accordance with one or more embodiments.

FIG. 3 illustrates example method(s) of defective code warning resolution analysis in accordance with one or more embodiments.

FIG. 4 illustrates example method(s) of defective code warning resolution analysis in accordance with one or more embodiments.

FIG. 5 illustrates various components of an example device that can implement embodiments of defective code warning resolution analysis.

### DETAILED DESCRIPTION

Defective code warning resolution analysis is described. In embodiments, an analysis algorithm is implemented to receive defective code warnings, such as code development warnings and/or code execution warnings. The analysis algorithm tracks the warning states of aggregated instances of the defective code warnings, and in combination with heuristics, determines or infers what action, if any, a developer initiated to resolve a defective code warning. Additionally, the aggregated instances of defective code warnings in the warning groups can be analyzed to infer diagnostic response behaviors and/or response trends to a defective code warning.

While features and concepts of defective code warning resolution analysis can be implemented in any number of different devices, systems, environments, networks and/or configurations, embodiments of defective code warning resolution analysis are described in the context of the following example devices, systems, and methods.

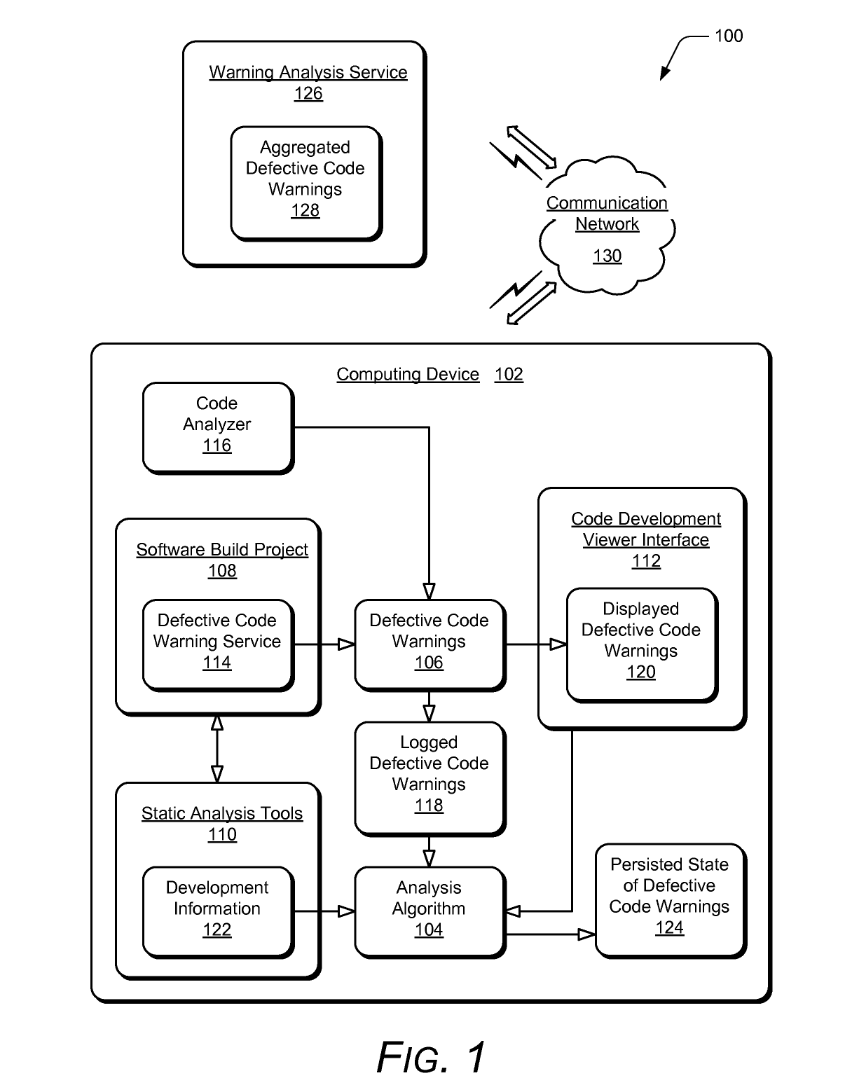

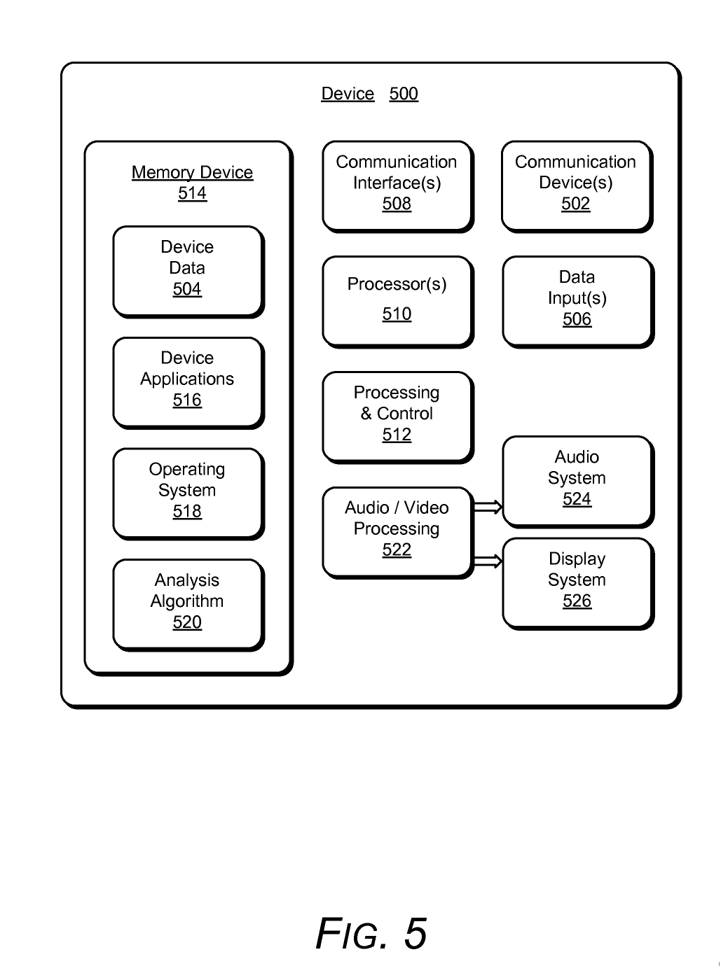

FIG. 1 illustrates an example system 100 in which various embodiments of defective code warning resolution analysis can be implemented. The system includes an example computing device 102 that may be any type of a computer, server, dedicated machine, state machine, and the like. The computing device can be implemented with various components, such as one or more processors and memory devices, as well as any number and combination of differing components as further described with reference to the example device shown in FIG. 5. The processors and memory of the computing device implement an analysis algorithm 104 as computer-executable instructions, such as a software application, that is executable to implement the various embodiments of defective code warning resolution analysis described herein. In embodiments, the analysis algorithm 104 is implemented as an instrumentation library. Alternatively, the analysis algorithm may be implemented as an independent service separate from the computing device, such as on a separate server or device, or by a third party service.

In various embodiments, the analysis algorithm 104 is implemented to receive and analyze defective code warnings 106, such as code development warnings, code execution warnings, and/or other types of defective code warnings. The analysis algorithm tracks the instances of defective code warnings and corresponding heuristics. In this example, the computing device 102 may be utilized by a software developer, also referred to as a programmer or user of the computing device. The computing device includes a software build project 108 and static analysis tools 110 that the developer utilizes to program and develop the software build project. A build system or build project may also include a code development viewer interface 112, also referred to as a static analysis viewer.

The software build project 108 includes a defective code warning service 114 that generates defective code warnings 106, such as code development warnings. The static analysis tools 110 may also generate defective code warnings that are routed via the defective code warning service. A code analyzer 116 may execute on the computing device 102 and also generate defective code warnings, such as code execution warnings. The defective code warnings 106 may be recorded as logged defective code warnings 118 and/or derived from traces generated in an operational environment. Alternatively or in addition, the defective code warnings 106 may be viewable to a developer in the code development viewer interface 112 as displayed defective code warnings 120.

The analysis algorithm 104 can then receive the displayed defective code warnings 120 and/or the logged defective code warnings 118. The analysis algorithm may also receive development information 122 from the static analysis tools. The development information can include information pertaining to the defective code warnings 106, such as whether defective code that caused a defective code warning to be initiated has been repaired or fixed, whether a defective code warning has been suppressed by use of a warning bypass that eliminates a reoccurrence of the defective code warning being displayed for viewing, or whether a code file from which a defective code warning originates has been checked (e.g., compiled or executed) to determine if the defective code warning is initiated again. Other development information can include heuristics, such as an estimate of response to a defective code warning based on how long a developer investigates a particular defective code warning and/or based on user-selectable inputs, such as mouse clicks, and the time duration between the user-selectable inputs.

In embodiments, the analysis algorithm 104 is implemented to group the defective code warnings into one or more warning groups according to properties of each defective code warning. For example, instances of a particular defective code warning may occur several times, and the instances of the particular defective code warning are categorized in a warning group. Additionally, the analysis algorithm can determine a warning state of each instance of a defective code warning in a warning group as one of fixed, suppressed, or ignored. A determination of a warning state can be determined or inferred from the development information 122 without requesting resolution input from a user or developer.

For example, The analysis algorithm 104 can determine that a defective code warning is fixed based on a repair of defective code that caused the defective code warning to be initiated. Alternatively, the analysis algorithm can determine the defective code warning is suppressed based on implementation of a warning bypass that eliminates a reoccurrence of the defective code warning being displayed for viewing. Alternatively, the analysis algorithm can determine the defective code warning is ignored if the defective code warning is not determined fixed or suppressed.

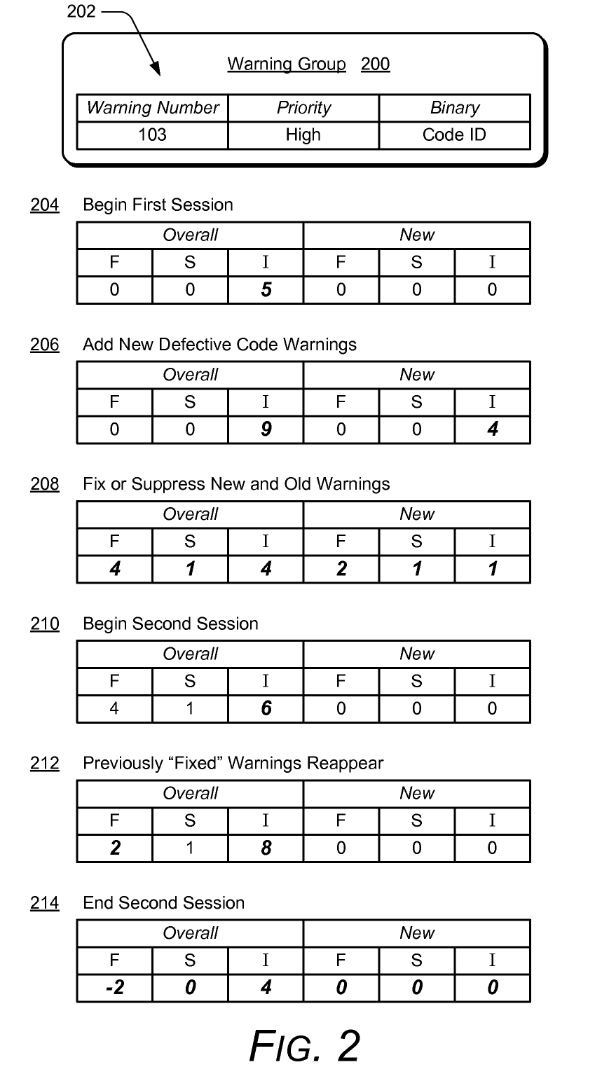

The analysis algorithm 104 is also implemented to aggregate each instance of the defective code warning in the warning group based on each warning state of fixed, suppressed, or ignored. The aggregated instances of the different types of defective code warnings in the one or more warning groups can then be saved or maintained as the persisted state of defective code warnings 124. These features of defective code warning resolution analysis are further described with reference to the example shown in FIG. 2.

In embodiments, the defective code warnings 106 may be received during more than one computing session. Accordingly, the analysis algorithm 104 is implemented to group the defective code warnings received during a previous computing session with the defective code warnings received during a subsequent computing session. Additionally, each instance of the defective code warning in the warning group is updated based on each determined warning state of fixed, suppressed, or ignored.

The example system 100 also includes a warning analysis service 126 that is a central database that receives aggregated defective code warnings 128 from multiple computing devices, such as computing device 102. In embodiments, the warning analysis service and/or the analysis algorithm 104 at the computing device can analyze the aggregated instances of defective code warnings in the one or more warning groups to infer a diagnostic response behavior and/or response trends to a defective code warning based on the warning states.

The computing device 102 communicates the aggregated defective code warnings 128 to the warning analysis service 126 via a communication network 130, which can be implemented to include wired and/or wireless networks. The communication network can also be implemented using any type of network topology and/or communication protocol, and can be represented or otherwise implemented as a combination of two or more networks, to include IP-based networks and/or the Internet.

FIG. 2 illustrates an example warning group 200 for instances of a defective code warning in accordance with the various embodiments described herein. The warning group includes instances of a particular defective code warning that is identified by properties 202. The instances of the defective code warning are grouped based on the properties that are common to many defective code warnings, such as a warning number, the warning priority, and the binary being built. All of the instances of the defective code warning are aggregated in the warning group on a local machine (e.g., the computing device 102), and then summaries and updates are communicated to a central database (e.g., the warning analysis service 126). In this example, the defective code warning is warning number 103 of a High priority having a particular code identification. The warning group could be based on additional properties as well, such as file name and/or code function, to further distinguish instances of defective code warnings.

The warning number indicates a unique class of defects and may correlate to all of the “null pointer” defective code warnings, all of the “race condition” defective code warnings, or any other instances of defective code warnings that have a particular defect in common. The priority property of the warning group may be any alphanumeric indication of priority for the particular defective code warning. The binary property of the warning group can indicate the binary file, directory, component, library, or device driver from which the defective code warning is initiated.

The analysis algorithm 104 described with reference to FIG. 1 is implemented to aggregate the overall instances of the defective code warning in the warning group 200 based on each warning state of fixed “F”, suppressed “S”, or ignored “I”. When a developer launches the viewer interface 112 to begin a first session at 204, all of the instances of the defective code warning (five in this example) are included in the Overall Ignored count. If any new instances of the defective code warning (four in this example) are added during the first session at 206, then they are included in both the New Ignored and Overall Ignored counts.

When instances of the defective code warning are then fixed or suppressed at 208, they are subtracted from the New and Overall Ignored counts and identified as Overall Fixed or Suppressed, and New Fixed or Suppressed. As shown at 208, two of the new instances of the defective code warning are fixed. These two instances are an example of the defect code warning instances that are transitory in nature and would otherwise not be tracked because they would not be posted into the code repository. At the end of the first session (i.e., after 208) a snapshot of the final counts for this warning group as shown at 208 is communicated to the central database (e.g., the warning analysis service 126).

As described above, changes may occur between sessions. At the start of each subsequent session, such as a second session at 210, the analysis algorithm 104 determines instances of the defective code warning that has changed warning state, or has been received between sessions, which is reflected in the Overall counts at 210. The New counts are also reset to zero. During this second session, it is possible that some instances of the defective code warning that were previously marked as Fixed reappear in the viewer interface at 212. This effectively reduces the total number of the Overall Fixed count. This change is reflected in the next update to the server at the end of the second session at 214, which includes a negative number for the Overall Fixed count. The update is computed by subtracting the snapshot at the end of the first session (i.e., after 208) from the snapshot at the end of the second session at 214. The central database then reflects the state of the desktop after each update.

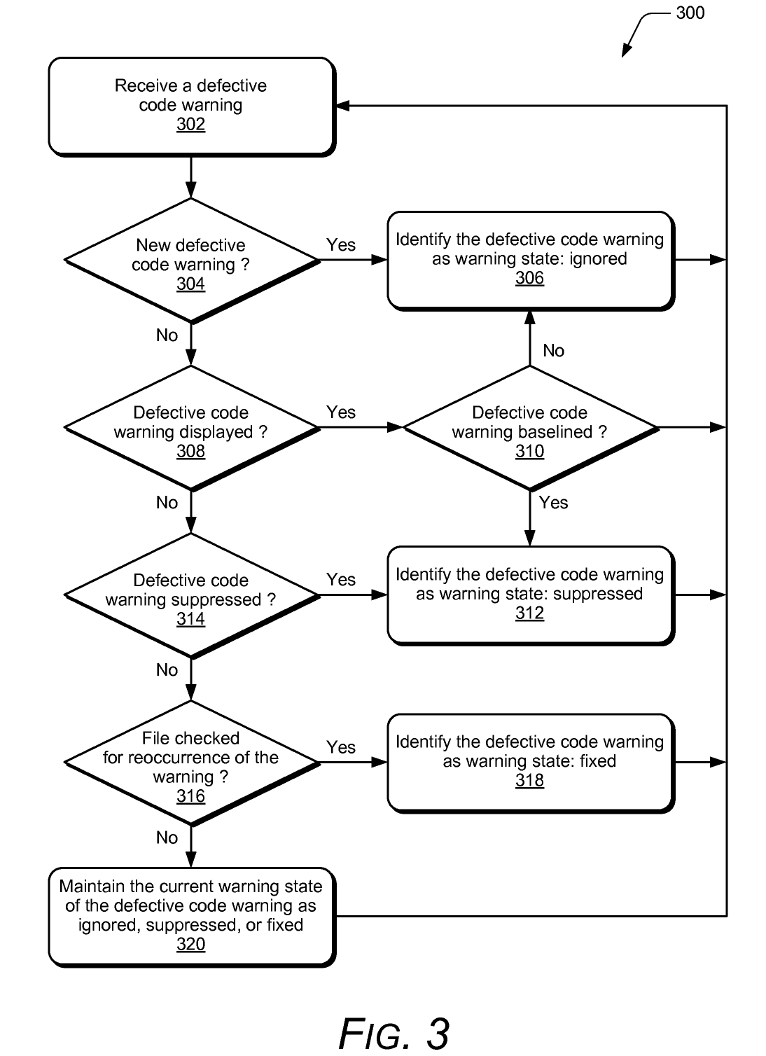

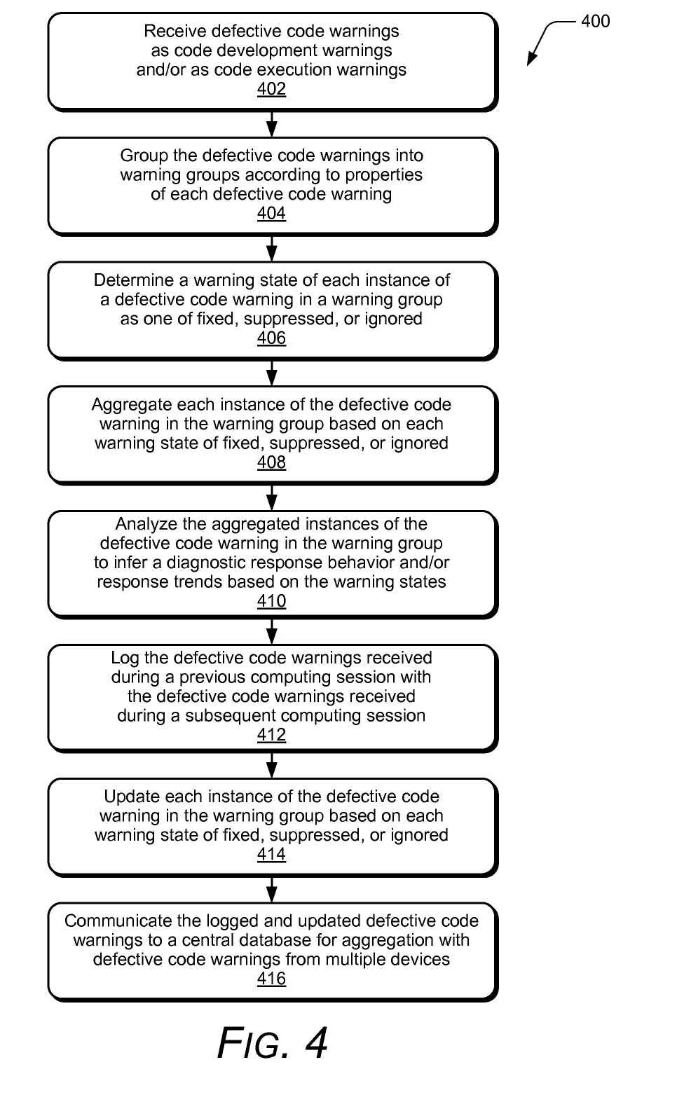

Example methods 300 and 400 are described with reference to respective FIGS. 3 and 4 in accordance with one or more embodiments of defective code warning resolution analysis. Generally, any of the services, functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable storage media devices, both local and/or remote to a computer processor. The methods may also be practiced in a distributed computing environment by multiple computer devices. Further, the features described herein are platform-independent and can be implemented on a variety of computing platforms having a variety of processors.

FIG. 3 illustrates example method(s) 300 of defective code warning resolution analysis. The order in which the method blocks are described are not intended to be construed as a limitation, and any number of the described method blocks can be combined in any order to implement a method, or an alternate method.

At block 302, a defective code warning is received. For example, the analysis algorithm 104 (FIG. 1) at the computing device 102 receives a defective code warning 106 and determines a warning state of the defective code warning as one of ignored, suppressed, or fixed as described with reference to the following method blocks 304-320. The analysis algorithm infers the warning state of a defective code warning because the source code of the software build project 108 is not parsed, key strokes are not monitored, and user resolution input is not requested.

At block 304, a determination is made as to whether the defective code warning is new. For example, the analysis algorithm 104 is implemented to assume that when a new defective code warning is received, it is identified as ignored. The warning state ignored is not an active user choice, and until the warning state of a defective code warning is updated as suppressed or fixed, the defective code warning is assumed ignored. If the defective code warning is new (i.e., “yes” from block 304), then at block 306, the new defective code warning is identified as ignored, and the method continues at block 302 to receive another defective code warning or another instance of the defective code warning. If the defective code warning is not new (i.e., “no” from block 304), then at block 308, a determination is made as to whether the defective code warning is displayed. For example, the defective code warning can be displayed for user or developer viewing in the code development viewer interface 112.

If the defective code warning is displayed (i.e., “yes” from block 308), then at block 310, a determination is made as to whether the defective code warning has been baselined. For example, a defective code warning may be baselined when identified as suppressed so as not to be displayed as a warning. If the defective code warning is not baselined (i.e., “no” from block 310), then at block 306, the defective code warning is identified as ignored, and the method continues at block 302 to receive another defective code warning or another instance of the defective code warning. If the defective code warning is baselined (i.e., “yes” from block 310), then at block 312, the defective code warning is identified as suppressed, and the method continues at block 302 to receive another defective code warning or another instance of the defective code warning.

If the defective code warning is not displayed (i.e., “no” from block 308), then at block 314, a determination is made as to whether the defective code warning has been suppressed. For example, a defective code warning may be suppressed when a developer initiates a warning bypass that eliminates a reoccurrence of the defective code warning being displayed. The defective code condition that causes the defective code warning has not been fixed, but the defective code warning is not displayed. The analysis algorithm 104 can determine that a defective code warning is suppressed based on heuristics, such as may be derived from the development information 122 from the static analysis tools 110. A static analysis tool may generate a defective code warning that does not appear in the viewer interface 112 because the developer has initiated a warning bypass (e.g. inserts a source level statement that suppresses the warning). To determine this, the static analysis tools 110 are implemented to inform the analysis algorithm of all defective code warnings that are generated. The analysis algorithm then compares all of the defective code warnings that are generated to the warnings that are displayed in the viewer interface, and if a warning is generated but not displayed, then the warning can be inferred as having been suppressed. Additionally, the analysis algorithm may determine defective code warnings that have been suppressed in other ways.

If the defective code warning has been suppressed (i.e., “yes” from block 314), then at block 312, the defective code warning is identified as suppressed, and the method continues at block 302 to receive another defective code warning or another instance of the defective code warning. If the defective code warning has not been suppressed (i.e., “no” from block 314), then at block 316, a determination is made as to whether the code file from which the defective code warning originated has been checked for a reoccurrence of the warning. For example, a defective code warning may be initiated from a code file when the code file is executed or compiled, and defective code initiates the defective code warning.

If the file from which the defective code warning originated has been checked for a reoccurrence of the warning (i.e., “yes” from block 316), then at block 318, the defective code warning is identified as fixed, and the method continues at block 302 to receive another defective code warning or another instance of the defective code warning. For example, a defective code warning may be inferred or determined to have been fixed when the defective code warning is not new (at block 304), not displayed (at block 308), not suppressed (at block 314), and the code file has been checked (at block 316). If the file from which the defective code warning originated has not been checked for a reoccurrence of the warning (i.e., “no” from block 316), then at block 320, the current warning state of the defective code warning is maintained as one of ignored, suppressed, or fixed, and the method continues at block 302 to receive another defective code warning or another instance of the defective code warning.

FIG. 4 illustrates example method(s) 400 of defective code warning resolution analysis. The order in which the method blocks are described are not intended to be construed as a limitation, and any number of the described method blocks can be combined in any order to implement a method, or an alternate method.

At block 402, defective code warnings are received as code development warnings and/or as code execution warnings. For example, the analysis algorithm 104 (FIG. 1) at the computing device 102 receives defective code warnings 106 as code development warnings and/or code execution warnings. The defective code warnings may be received as displayed defective code warnings, analyzer determined defective code warnings, and/or logged defective code warnings. Additionally, the defective code warnings may be received during more than one computing session.

At block 404, the defective code warnings are grouped into warning groups according to properties of each defective code warning. For example, the analysis algorithm 104 groups instances of a defective code warning into a warning group 200 (FIG. 2) based on the properties 202 that are common to the instances of the defective code warning.

At block 406, a warning state of each instance of a defective code warning in a warning group is determined as one of fixed, suppressed, or ignored. For example, the analysis algorithm 104 determines a warning state of each instance of a defective code warning in a warning group as one of fixed, suppressed, or ignored. A determination of a warning state can be determined or inferred from the development information 122 without requesting resolution input from a user or developer. A defective code warning is determined fixed based on a repair of defective code that caused the defective code warning to be initiated. Alternatively, the defective code warning is determined suppressed based on implementation of a warning bypass that eliminates a reoccurrence of the defective code warning being displayed for viewing.

Alternatively, the defective code warning is determined ignored if the defective code warning is not determined as fixed or suppressed.

At block 408, each instance of the defective code warning in the warning group is aggregated based on each warning state of fixed, suppressed, or ignored. For example, the analysis algorithm 104 aggregates each instance of the defective code warning in the warning group 200 based on each warning state of fixed, suppressed, or ignored. The aggregated instances of the different types of defective code warnings in the one or more warning groups can then be saved or maintained as the persisted state of defective code warnings 124 at the computing device 102.

At block 410, the aggregated instances of the defective code warning in the warning group are analyzed to infer a diagnostic response behavior and/or response trends to the defective code warning based on the warning states. For example, the warning analysis service 126 and/or the analysis algorithm 104 at the computing device 102 analyzes the aggregated instances of defective code warnings in the one or more warning groups to infer a diagnostic response behavior and/or response trends to a defective code warning based on the warning states.

At block 412, the defective code warnings received during a previous computing session are logged with the defective code warnings received during a subsequent computing session. For example, the defective code warnings 106 may be received during more than one computing session, and the analysis algorithm 104 groups the defective code warnings received during a previous computing session with the defective code warnings received during a subsequent computing session (e.g., repeat block 404 to group the defective code warnings into the warning groups according to properties of each defective code warning).

At block 414, each instance of the defective code warning in the warning group is updated based on each warning state of fixed, suppressed, or ignored. For example, the analysis algorithm 104 updates each instance of the defective code warning in the warning group 200 based on each determined warning state of fixed, suppressed, or ignored (e.g., repeat blocks 406 and 408 to determine a warning state of each instance of a defective code warning and aggregate each instance of the defective code warning in the warning group based on the determined warning state).

At block 416, the defective code warnings that are logged into the warning groups and updated based on warning state are communicated to a central database for aggregation with defective code warnings from multiple devices. For example, the analysis algorithm 104 initiates communicating the updated and logged defective code warnings to the warning analysis service 128 (e.g. a central database) that maintains the aggregated defective code warnings 128 from multiple computing devices.

FIG. 5 illustrates various components of an example device 500 that can be implemented as any of the devices, or services implemented by devices, described with reference to the previous FIGS. 1-4. In embodiments, the device may be implemented as any one or combination of a fixed or mobile device, in any form of a consumer, computer, server, portable, user, communication, phone, navigation, television, appliance, gaming, media playback, and/or electronic device. The device may also be associated with a user (i.e., a person) and/or an entity that operates the device such that a device describes logical devices that include users, software, firmware, hardware, and/or a combination of devices.

The device 500 includes communication devices 502 that enable wired and/or wireless communication of device data 504, such as received data, data that is being received, data scheduled for broadcast, data packets of the data, etc. The device data or other device content can include configuration settings of the device, media content stored on the device, and/or information associated with a user of the device. Media content stored on the device can include any type of audio, video, and/or image data. The device includes one or more data inputs 506 via which any type of data, media content, and/or inputs can be received, such as user-selectable inputs, messages, communications, music, television content, recorded video content, and any other type of audio, video, and/or image data received from any content and/or data source.

The device 500 also includes communication interfaces 508, such as any one or more of a serial, parallel, network, or wireless interface. The communication interfaces provide a connection and/or communication links between the device and a communication network by which other electronic, computing, and communication devices communicate data with the device.

The device 500 includes one or more processors 510 (e.g., any of microprocessors, controllers, and the like) which process various computer-executable instructions to control the operation of the device. Alternatively or in addition, the device can be implemented with any one or combination of software, hardware, firmware, or fixed logic circuitry that is implemented in connection with processing and control circuits which are generally identified at 512. Although not shown, the device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The device 500 also includes one or more memory devices 514 (e.g., computer-readable storage media) that enable data storage, such as random access memory (RAM), non-volatile memory (e.g., read-only memory (ROM), flash memory, etc.), and a disk storage device. A disk storage device may be implemented as any type of magnetic or optical storage device, such as a hard disk drive, a recordable and/or rewriteable disc, and the like. The device may also include a mass storage media device.

Computer readable media can be any available medium or media that is accessed by a computing device. By way of example, and not limitation, computer readable media may comprise storage media and communication media. Storage media include volatile and non-volatile, removable and non-removable media implemented in any method or technology for storage of information, such as computer-readable instructions, data structures, program modules, or other data. Storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computer.

Communication media typically embody computer-readable instructions, data structures, program modules, or other data in a modulated data signal, such as carrier wave or other transport mechanism. Communication media also include any information delivery media. The term modulated data signal means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

A memory device 514 provides data storage mechanisms to store the device data 504, other types of information and/or data, and various device applications 516. For example, an operating system 518 can be maintained as a software application with a memory device and executed on the processors. The device applications may also include a device manager, such as any form of a control application, software application, signal processing and control module, code that is native to a particular device, a hardware abstraction layer for a particular device, and so on. In this example, the device applications 516 include an analysis algorithm 520. The analysis algorithm is shown as software and/or computer application. Alternatively or in addition, the analysis algorithm can be implemented as hardware, software, firmware, fixed logic, or any combination thereof

The device 500 also includes an audio and/or video processing system 522 that generates audio data for an audio system 524 and/or generates display data for a display system 526. The audio system and/or the display system may include any devices that process, display, and/or otherwise render audio, video, display, and/or image data. Display data and audio signals can be communicated to an audio device and/or to a display device via an RF (radio frequency) link, S-video link, composite video link, component video link, DVI (digital video interface), analog audio connection, or other similar communication link. In implementations, the audio system and/or the display system are external components to the device. Alternatively, the audio system and/or the display system are integrated components of the example device.

Although embodiments of defective code warning resolution analysis have been described in language specific to features and/or methods, the subject of the appended claims is not necessarily limited to the specific features or methods described. Rather, the specific features and methods are disclosed as example implementations of defective code warning resolution analysis.

1. A computer-implemented method, comprising:
receiving defective code warnings;
grouping the defective code warnings into one or more warning groups according to properties of each defective code warning;
determining a warning state of each instance of a defective code warning in a warning group as one of fixed, suppressed, or ignored; and
aggregating each instance of the defective code warning in the warning group based on each warning state of fixed, suppressed, or ignored.

2. A computer-implemented method as recited in claim 1, wherein each of the defective code warnings are received as at least one of a code development warning or a code execution warning.

3. A computer-implemented method as recited in claim 1, wherein each of the defective code warnings are received as at least one of a displayed defective code warning, an analyzer determined defective code warning, or a logged defective code warning.

4. A computer-implemented method as recited in claim 1, wherein:
the defective code warning is determined fixed based on a repair of defective code that caused the defective code warning to be initiated;
the defective code warning is determined suppressed based on implementation of a warning bypass that eliminates a reoccurrence of the defective code warning; or
the defective code warning is determined ignored if the defective code warning is not said fixed or suppressed.

5. A computer-implemented method as recited in claim 1, wherein each instance of the defective code warning in the warning group is determined as said one of fixed, suppressed, or ignored without requested resolution input.

6. A computer-implemented method as recited in claim 1, further comprising analyzing the aggregated instances of the defective code warning in the warning group to infer a diagnostic response behavior to the defective code warning based on the warning states.

7. A computer-implemented method as recited in claim 1, further comprising analyzing the aggregated instances of the defective code warning in the warning group to infer one or more response trends to the defective code warning based on the warning states.

8. A computer-implemented method as recited in claim 1, wherein the defective code warnings are received during more than one computing session, the computer-implemented method further comprising:
logging the defective code warnings received during a previous computing session with the defective code warnings received during a subsequent computing session; and
updating each instance of the defective code warning in the warning group based on each warning state of fixed, suppressed, or ignored.

9. A computing device, comprising:
a code development viewer interface configured to display defective code warnings;
at least a memory and a processor to implement an analysis algorithm that is configured to:
receive the defective code warnings;
group the defective code warnings into one or more warning groups according to properties of each defective code warning;
determine a warning state of each instance of a defective code warning in a warning group as one of fixed, suppressed, or ignored; and
aggregate each instance of the defective code warning in the warning group based on each warning state of fixed, suppressed, or ignored.

10. A computing device as recited in claim 9, wherein the analysis algorithm is further configured to receive each of the defective code warnings as at least one of a code development warning or a code execution warning.

11. A computing device as recited in claim 9, wherein the analysis algorithm is further configured to receive each of the defective code warnings as at least one of a displayed defective code warning, an analyzer determined defective code warning, or a logged defective code warning.

12. A computing device as recited in claim 9, wherein the analysis algorithm is further configured to:
determine the defective code warning is fixed based on a repair of defective code that caused the defective code warning to be initiated;
determine the defective code warning is suppressed based on implementation of a warning bypass that eliminates a reoccurrence of the defective code warning; or
determine the defective code warning is ignored if the defective code warning is not determined fixed or suppressed.

13. A computing device as recited in claim 9, wherein the analysis algorithm is further configured to determine each instance of the defective code warning in the warning group as said one of fixed, suppressed, or ignored without requested resolution input.

14. A computing device as recited in claim 9, wherein the analysis algorithm is further configured to analyze the aggregated instances of the defective code warning in the warning group to infer a diagnostic response behavior to the defective code warning based on the warning states.

15. A computing device as recited in claim 9, wherein the analysis algorithm is further configured to analyze the aggregated instances of the defective code warning in the warning group to infer one or more response trends to the defective code warning based on the warning states.

16. A computing device as recited in claim 9, wherein the analysis algorithm is further configured to:
receive the defective code warnings during more than one computing session;
log the defective code warnings received during a previous computing session with the defective code warnings received during a subsequent computing session; and
update each instance of the defective code warning in the warning group based on each warning state of fixed, suppressed, or ignored.

17. One or more computer-readable storage media devices comprising instructions that are executable and, responsive to executing the instructions, a computing device implements an analysis algorithm to:
group defective code warnings into one or more warning groups according to properties of each defective code warning;
determine a warning state of each instance of a defective code warning in a warning group as one of fixed, suppressed, or ignored; and
aggregate each instance of the defective code warning in the warning group based on each warning state of fixed, suppressed, or ignored.

18. One or more computer-readable storage media devices as recited in claim 17, further comprising additional instructions that are executable and, responsive to executing the additional instructions, the computing device implements the analysis algorithm to:
determine the defective code warning is fixed based on a repair of defective code that caused the defective code warning to be initiated;
determine the defective code warning is suppressed based on implementation of a warning bypass that eliminates a reoccurrence of the defective code warning; or
determine the defective code warning is ignored if the defective code warning is not said fixed or suppressed.

19. One or more computer-readable storage media devices as recited in claim 17, further comprising additional instructions that are executable and, responsive to executing the additional instructions, the computing device implements the analysis algorithm to analyze the aggregated instances of the defective code warning in the warning group to infer a diagnostic response behavior to the defective code warning based on the warning states.

20. One or more computer-readable storage media devices as recited in claim 17, further comprising additional instructions that are executable and, responsive to executing the additional instructions, the computing device implements the analysis algorithm to analyze the aggregated instances of the defective code warning in the warning group to infer one or more response trends to the defective code warning based on the warning states.
